(19) United States
(12) Patent Application Publication
(10) Pub. No.: US 2019/0106925 A1
(43) Pub. Date: Apr. 11, 2019

(54) VARIABLE LEAD SCREW FOR POWER DOOR ACTUATOR

(71) Applicant: MAGNA CLOSURES INC., Newmarket (CA)

(72) Inventor: John P. McCORKELL, Orillia (CA)

(21) Appl. No.: 16/155,095

(22) Filed: Oct. 9, 2018

Related U.S. Application Data
(60) Provisional application No. 62/570,755, filed on Oct. 11, 2017.

(51) Int. Cl. E05F 15/622; E05B 81/12; E05B 81/40; F16H 25/24

(52) U.S. Cl. CPC E05F 15/622; E05B 81/12; E05B 81/40; F16H 2025/2075; E05Y 2900/546; E05Y 2900/531; F16H 25/24

(57) ABSTRACT

A variable pitch lead screw assembly and actuator assembly therewith is provided. The lead screw assembly includes a lead screw having a groove extending helically along a length of the lead screw. The groove is formed having a varying pitch. A drive nut is provided having a body with a through bore configured for receipt of the lead screw therethrough. The drive nut has teeth extending radially inwardly into the through bore for receipt in the groove of the lead screw. The teeth are pivotal in multiple directions relative to the body to allow the teeth to pivot in multiple directions within the groove.

### CROSS-REFERENCE TO RELATED APPLICATION

This application claims the benefit of U.S. Provisional Application Ser. No. 62/570,755, filed Oct. 11, 2017, which is incorporated herein by reference in its entirety.

### FIELD

The present disclosure relates generally to power door systems for motor vehicles and, more particularly, to a power door actuator operable for moving a vehicle door relative to a vehicle body between an open position and a closed position.

### BACKGROUND

This section provides background information related to the present disclosure which is not necessarily prior art.

Automotive closure members, such as lift gates and other types of door closure members in general, provide a convenient access to the cargo and passenger areas of automotive vehicles, such as hatchbacks, wagons, and other utility vehicles. Typically, the lift gate, as well as other door closure members, is hand operated, requiring manual effort to move the lift gate between open and the closed positions. Depending on the size and weight of the lift gate, the effort required to move the lift gate between open and closed positions can be difficult for some users, particularly as the lift gate is moved toward a fully opened position, where the full weight of the lift gate must be supported. Additionally, manually opening and/or closing a lift gate can be made inconvenient, particularly when the user's hands are occupied.

Attempts have been made to facilitate opening and closing lift gates, such as via powered opening devices, such as electromechanical struts. Electromechanical struts typically have a linear actuation assembly including a constant pitch lead screw and a nut tube, with rotation of the lead screw causing linear translation of the nut tube, which in turn is operably attached the lift gate. Accordingly, rotation of the lead screw causes the lift gate to be moved between open and closed positions. Although these devices generally prove useful in reducing the effort required by the user to move the lift gate between open and closed positions, the devices can be subject to overloading, which can result in a diminished useful life of the device, while also resulting in undesirable noise and an overall perception of poor quality. Overloading is particularly problematic when the lift gate is being opened, and more particularly when the lift gate is moving between halfway opened (when the lift gate is horizontal to a ground surface) and a fully opened positions (when the lift gate is extended upwardly from the ground surface), as this is when the electromechanical strut must support and move the full weight of the lift gate. Having to move the full weight of the lift gate between the halfway and fully opened positions requires significant increase in torque from the leadscrew, which in turn, places the motor driving the leadscrew under a significantly increased demand, thereby placing the electromechanical strut under high load/high stress during this range of lift gate movement. Accordingly, in order to account for this high load/high stress condition, the size of the motor is typically increased to achieve the following: to move the lift gate in a smooth, quiet and relatively constant rate fashion without delay and more efficiently since the motor will not need to overcome inefficient pitch angles over the length of the lead screw, as well as to extend the useful life of the electromechanical strut. Otherwise, if the motor size is not adequate, the useful life of the powered opening device becomes diminished. Unfortunately, among other things, which are known to those skilled in the art, increasing the size of the motor to extend the useful life of the powered opening device increases its size, increases its weight, and increases its cost, all of which are highly undesirable.

It is therefore desired to provide an electromechanical strut for opening and closing a vehicle trunk lid, door or lift gate, or other closure panel, that obviates or mitigates at least one of the above-identified disadvantages.

### SUMMARY

This section provides a general summary of the present disclosure and is not a comprehensive disclosure of its full scope or all of its features, aspects and objectives.

It is an aspect of the present disclosure to provide a variable pitch power door actuator for use in a power door actuation system and which is operable for moving a vehicle door between open and closed positions relative to a vehicle body.

It is another aspect of the present disclosure to provide a variable pitch power swing door actuator for use with swing doors in motor vehicles which can be effectively packaged within the cavity of the door and cooperatively interact with a door hinge.

It is another aspect of the present disclosure to provide a variable pitch power swing door actuator for use with lift gates in motor vehicles.

It is another aspect of the present disclosure to provide a variable pitch lead screw assembly for use in a cinch actuator in motor vehicles.

It is another aspect of the present disclosure to provide a variable pitch cinch actuator for use with a latch mechanism in motor vehicles.

It is another aspect of the present disclosure to provide a lead screw assembly for a closure panel actuator for moving a vehicle closure panel relative to a vehicle body between a closed position and an open position. The lead screw assembly includes a lead screw having a groove extending helically along a length of the lead screw. The groove is formed having a varying pitch. A drive nut is provided having a body with a through bore configured for receipt of the lead screw therethrough. The drive nut has teeth extending radially inwardly into the through bore for receipt in the groove of the lead screw. The teeth are pivotal relative to the body to allow the teeth to pivot within the varying pitch of the groove.

It is another aspect of the present disclosure to provide the body of the drive nut having diametrically opposed receptacles facing radially inwardly toward the through bore. Further yet, forming each of the teeth as an integral piece of material with a separate guide member body, and configuring each guide member body for pivotal movement in a separate one of the diametrically opposed receptacles.

It is another aspect of the present disclosure to provide the receptacles having a concave contour and the guide member bodies having a convex contour, with the concave contour mating with the convex contour for relative pivotal movement therebetween.

It is another aspect of the present disclosure to provide each of the teeth having opposite elongate sides converging toward one another away from the guide member body to a free edge.

It is another aspect of the present disclosure to provide the varying pitch as being continuously varying.

It is another aspect of the present disclosure to provide a power door actuator for moving a vehicle door relative to a vehicle body between a closed position and an open position. The actuator includes a housing bounding an inner chamber with a motor gear assembly disposed therein. Further, a lead screw is supported in the inner chamber of the housing. The lead screw is operably coupled to the motor gear assembly for rotation in response to selective actuation of the motor gear assembly, with the lead screw having a helical groove with a varying pitch. Further, an extensible tube is disposed in the inner chamber and about the lead screw. A drive nut is fixed to the extensible tube. The drive nut has a body with a through bore configured for receipt of the lead screw therethrough. The drive nut includes teeth extending radially inwardly for receipt in the helical groove, wherein the teeth are pivotal relative to the body to allow the teeth to pivot within the varying pitch of the helical groove.

It is another aspect of the present disclosure to provide an actuator assembly including a lead screw extending lengthwise along a longitudinal central axis between opposite ends and a drive nut having a drive nut body with a through bore configured for receipt of the lead screw therethrough. The lead screw is provided having a groove extending helically along the length between the opposite ends, with the groove being formed having a varying pitch along at least a portion of the length of the lead screw. The drive nut is provided having teeth extending radially inwardly into the through bore toward the longitudinal axis for receipt in the groove. The teeth are formed of a separate piece of material from the drive nut body and are pivotal relative to the drive nut body to allow the teeth to follow the varying pitch of the groove.

It is a further aspect of the present disclosure to provide the actuator assembly having a housing bounding an inner chamber and a motor, with the lead screw being supported in the inner chamber and being operably coupled (meaning directly coupled or indirectly coupled, such as via an intervening gear train or connector) to the motor for rotation in opposite first and second directions in response to selective actuation of the motor. The actuator assembly further including an extensible member, wherein the drive nut is fixed to the extensible member such that the extensible member, and drive nut fixed thereto, translate conjointly along the longitudinal central axis between an extended position away from the housing when the lead screw rotates in the first direction and a retracted position toward the housing when the lead screw rotates in the second direction.

It is a further aspect of the present disclosure to provide the extensible member as a tubular member disposed within the housing and about the lead screw, with the extensible member being configured for attachment to a closure panel of a motor vehicle for moving the closure panel between an open position and a closed position in response to the extensible member and drive nut translating conjointly along the longitudinal central axis between the extended and retracted positions.

It is a further aspect of the present disclosure to configure the extensible member for operable attachment to a latch of a motor vehicle closure panel to move the latch between a cinched position and an un-cinched position.

It is another aspect of the present disclosure to provide a cinch actuator assembly for moving a latch of a vehicle closure panel between cinched and un-cinched positions. The cinch actuator assembly includes a motor and a lead screw operably coupled to the motor for rotation of the lead screw in opposite first and second directions in response to actuation of the motor. The lead screw is provided having a groove extending helically along its length, with the groove having a varying pitch along at least a portion of the length. The cinch actuator assembly further includes a drive nut having a drive nut body with a through bore configured for receipt of the lead screw therethrough and a plurality of guide members formed of a separate piece of material from the drive nut body. Each of the guide members is provided having a guide member body and a tooth extending radially inwardly from the guide member body into the through bore toward the longitudinal axis for receipt in the groove. Each guide member body is supported by the drive nut body for pivotal movement relative thereto to allow the teeth to follow the varying pitch of the groove. The cinch actuator assembly further includes an extensible member fixed to the drive nut such that the extensible member translates conjointly with the drive nut along the longitudinal central axis between an extended position when the lead screw rotates in the first direction and a retracted position when the lead screw rotates in the second direction to selectively move the latch from one of the cinched and un-cinched positions to the other of the cinched and un-cinched positions.

In accordance with another aspect, there is provided a method for moving a vehicle closure panel relative to a vehicle body between a closed position and an open position. The method includes the steps of providing a lead screw having a helical groove extending about a longitudinal central axis between opposite ends, with the helical groove having a varying pitch extending along the longitudinal central axis. Further, providing a motor and controlling the motor to drive the lead screw. Further, providing a drive nut having a drive nut body with a through bore configured for receipt of the lead screw therethrough and a plurality of guide members formed of a separate piece of material from the drive nut body, with each of the guide members having a guide member body and a tooth extending radially inwardly from the guide member body into the through bore toward the longitudinal central axis for receipt in the helical groove, wherein each guide member body is supported by the drive nut body. Further yet, allowing the tooth to follow the varying pitch of the helical groove and allowing the guide member to freely rotate around an indefinite number of axes in response to the tooth following the varying pitch of the helical groove. And, translating an extensible member fixed to the drive nut such that the extensible member translates along the longitudinal central axis between an extended position away from the housing when the lead screw rotates in the first direction to move the vehicle closure panel toward the open position and a retracted position toward the housing when the lead screw rotates in the second direction to move the vehicle closure panel toward the closed position.

In accordance with a further aspect, the method further includes the step of controlling the motor at a constant output speed, providing the lead screw with a varied pitch such that the constant output speed of the motor drives the translation of the extension member at a constant rate to move the vehicle closure panel toward the open position and a retracted position toward the housing at a constant rate.

Further areas of applicability will become apparent from the description provided herein. The description and specific embodiments listed in this summary are for purposes of illustration only and are not intended to limit the scope of the present disclosure.

### BRIEF DESCRIPTION OF THE DRAWINGS

These and other objects, features, and advantages of the present disclosure will be readily appreciated, as the same becomes better understood by reference to the following detailed description and appended claims when considered in connection with the accompanying drawings, wherein:

FIG. 1 is a perspective view of a motor vehicle having a powered closure system, shown as a powered lift gate and/or at least one powered swing door, for example, equipped with at least one electromechanical strut constructed in accordance with the teachings of the present disclosure;

FIG. 2 is a cross-sectional view taken generally along a longitudinal central axis of an electromechanical strut of FIG. 1 constructed in accordance with the teachings of the present disclosure;

FIGS. 3A, 3B and 3C are schematic views of a power swing door actuator system including an electromechanical strut constructed in accordance with the teachings of the present disclosure and which is operably arranged between a vehicle body and a swing door of the vehicle of FIG. 1 for moving the swing door between a closed position, one or more mid-positions, and an open position, respectively;

FIG. 4 is a fragmentary isometric view of a variable pitch lead screw and nut assembly of the electromechanical struts of FIGS. 2 and 3A-3C;

FIG. 5A is a fragmentary transparent side view of the variable pitch lead screw and nut assembly of FIG. 4;

FIG. 5B is a view similar to FIG. 5A illustrating multi-directional pivot movement of a pair of guide members of a drive nut along a longitudinal central axis of the variable pitch lead screw and nut assembly;

FIG. 5C is another view illustrating multi-directional pivot movement of the guide members of the drive nut circumferentially about the longitudinal central axis of the variable pitch lead screw and nut assembly;

FIG. 6 is a fragmentary side view of the variable pitch lead screw of the variable pitch lead screw and nut assembly of FIG. 4;

FIG. 6A is a view similar to FIG. 6 of a variable pitch lead screw in accordance with a further aspect of the disclosure;

FIG. 7 is a schematic isometric view of a follower member of a nut assembly of the variable pitch lead screw and nut assembly of FIG. 4;

FIG. 7A is a plan view of a guide member of nut assembly of a variable pitch lead screw and nut assembly in accordance with a further aspect of the disclosure;

FIG. 7B is a view similar to FIG. 7A of a guide member of nut assembly of a variable pitch lead screw and nut assembly in accordance with a further aspect of the disclosure;

FIG. 8 is a schematic transparent isometric view of a nut body of the nut assembly of the variable pitch lead screw and nut assembly of FIG. 4;

FIG. 9 is a cross-sectional view taken generally along a longitudinal central axis of a cinch actuator constructed in accordance with the teachings of the present disclosure;

FIG. 10 is a fragmentary isometric view of a variable pitch lead screw and nut assembly of the cinch actuator of FIG. 9;

FIG. 11 is an illustrative speed-torque curve of an electric motor; and

FIG. 12 is a flow diagram illustrating a method for moving a vehicle closure panel relative to a vehicle body between a closed position and an open position in accordance with the teachings of the present disclosure.

### DETAILED DESCRIPTION OF EXAMPLE EMBODIMENTS

In general, at least one example embodiment of a power-operated closure mechanism and system therewith in accordance with the teachings of the present disclosure will now be disclosed. The example embodiments are provided so that this disclosure will be thorough, and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known processes, well-known device structures, and well-known technologies are not described in detail, as they will be readily understood by the skilled artisan in view of the disclosure herein.

The terminology used herein is for the purpose of describing particular example embodiments only and is not intended to be limiting. As used herein, the singular forms “a,” “an,” and “the” may be intended to include the plural forms as well, unless the context clearly indicates otherwise. The terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed.

When an element or layer is referred to as being “on,” “engaged to,” “connected to,” or “coupled to” another element or layer, it may be directly on, engaged, connected or coupled to the other element or layer, or intervening elements or layers may be present. In contrast, when an element is referred to as being “directly on,” “directly engaged to,” “directly connected to,” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

Although the terms first, second, third, etc. may be used herein to describe various elements, components, regions, layers and/or sections, these elements, components, regions, layers and/or sections should not be limited by these terms. These terms may be only used to distinguish one element, component, region, layer or section from another region, layer or section. Terms such as “first,” “second,” and other numerical terms when used herein do not imply a sequence or order unless clearly indicated by the context. Thus, a first element, component, region, layer or section discussed below could be termed a second element, component, region, layer or section without departing from the teachings of the example embodiments.

Spatially relative terms, such as “inner,” “outer,” “beneath,” “below,” “lower,” “above,” “upper,” “top”, “bottom”, and the like, may be used herein for ease of description to describe one element's or feature's relationship to another element(s) or feature(s) as illustrated in the figures. Spatially relative terms may be intended to encompass different orientations of the device in use or operation in addition to the orientation depicted in the figures. For example, if the device in the figures is turned over, elements described as “below” or “beneath” other elements or features would then be oriented “above” the other elements or features. Thus, the example term “below” can encompass both an orientation of above and below. The device may be otherwise oriented (rotated degrees or at other orientations) and the spatially relative descriptions used herein interpreted accordingly.

Vehicles, particularly passenger vehicles, are equipped with moveable closure panels for providing openings, passages and access within and through defined portions of the vehicle body. To enhance operator convenience, many vehicles are now equipped with power-operated systems, such as power-operated closure systems to automatically control movement of all types of closure panels including, without limitation, hatch lift gates, side doors, trunk and hood deck lids, sliding and hinged (swing) doors, sun roofs and the like, and power-operated cinch actuators to facilitate cinching a latch. For purposes of descriptive clarity, the present disclosure is described herein in the context of a powered lift gate or side (swing) door. However, upon reading the following detailed description in conjunction with the appended drawings, it will be clear that the inventive concepts of the present disclosure can be applied to numerous other systems and applications, and thus, the specific embodiments described and shown herein are intended to be exemplary and not limiting.

In this regard, the present disclosure is generally directed to electromechanical struts and cinch actuators having a power-operated drive mechanism comprised of a housing, an electric motor, an optional reduction gear-set driven by the electric motor, a rotatable power screw assembly (also referred to as lead screw and nut assembly), a coupling device that is operably disposed between the optional reduction gear-set and the power screw or directly between the motor and the power screw, and an extensible member that is linearly translatable relative to the housing.

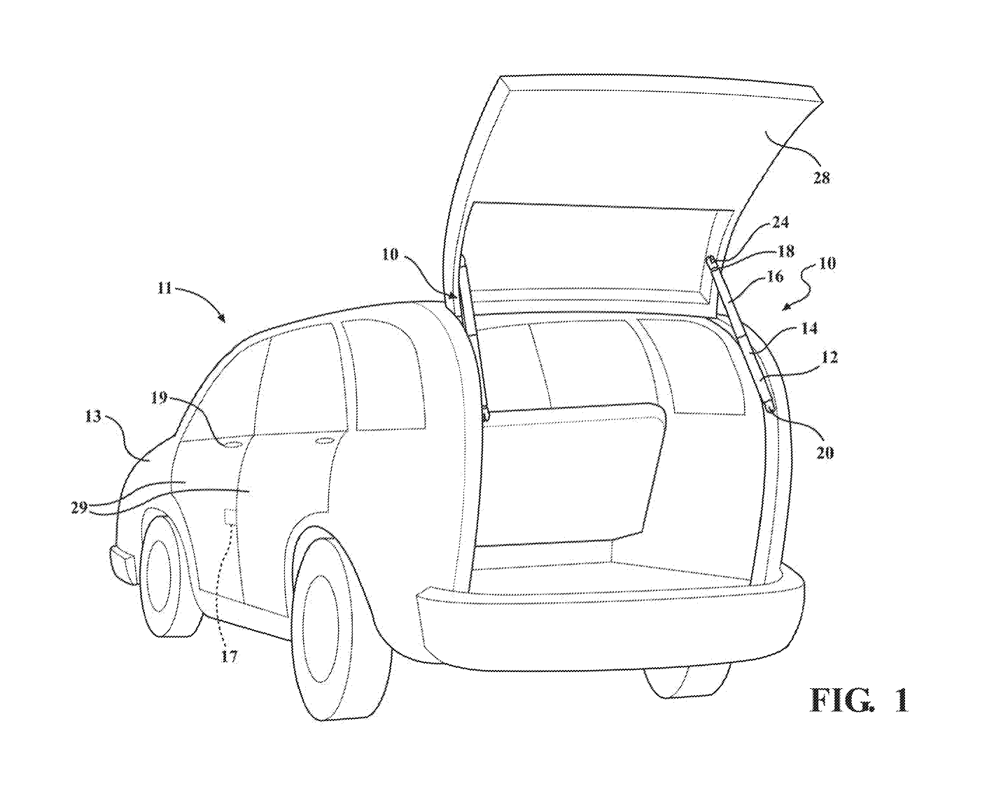

Referring now to FIG. 1, a non-limiting, exemplary embodiment of an actuator assembly, having a variable pitch lead screw assembly, shown as an electromechanical strut, by way of example and without limitation, referred to hereafter simply as strut 10, is shown mounted to a body 13 of a motor vehicle 11. Strut 10 includes a power drive unit 12 enveloped in an upper outer housing or tube, referred to hereafter simply as housing 14, and a telescoping unit, also referred to as extensible member 16, enveloped in an outer lower housing or tube, with extensible member 16 being shown having an extensible tubular member, also referred to as extensible tube or tube 18. A first pivot mount 20, such as a 10 mm ball stud, by way of example and without limitation, fixed to a first end 22 of the strut 10, is configured to be pivotally mounted to a portion of the vehicle body 13 adjacent an interior cargo area in the vehicle 11. A second pivot mount 24, such as a 10 mm ball stud, by way of example and without limitation, fixed to a second end 26 of the strut 10, shown as being fixed to extensible member 16, is configured to be attached to a closure panel of motor vehicle 11, shown as being pivotally mounted to a lift gate 28 of the vehicle 11, by way of example and without limitation. It is to be recognized that other closure panels of motor vehicle 11, including side doors (sliding and/or hinged) 29 and hood deck lids (not shown), sun roof (not shown) and the like, can also be equipped with an electromechanical strut constructed in accordance with the teachings, as is discussed with particular regard to the side swing doors 29 in more detail below.

The strut 10 includes a motor-gear assembly 30, which includes a motor 32, a gear box, if desired, also referred to as planetary gear set 34, and a power screw assembly, also referred to as variable pitch lead screw assembly or lead screw assembly 35, which includes a variable pitch lead screw 36 and drive nut 37. In an embodiment, the variable pitch lead screw 36 and drive nut 37 may each be formed from a plastic material. The strut 10 provides improved operation in a compact, reduced weight arrangement, such as by having minimal number of components, a reduced outer diameter or cross-sectional area, and a reduced weight, which is owed largely to the configuration of the lead screw assembly 35.

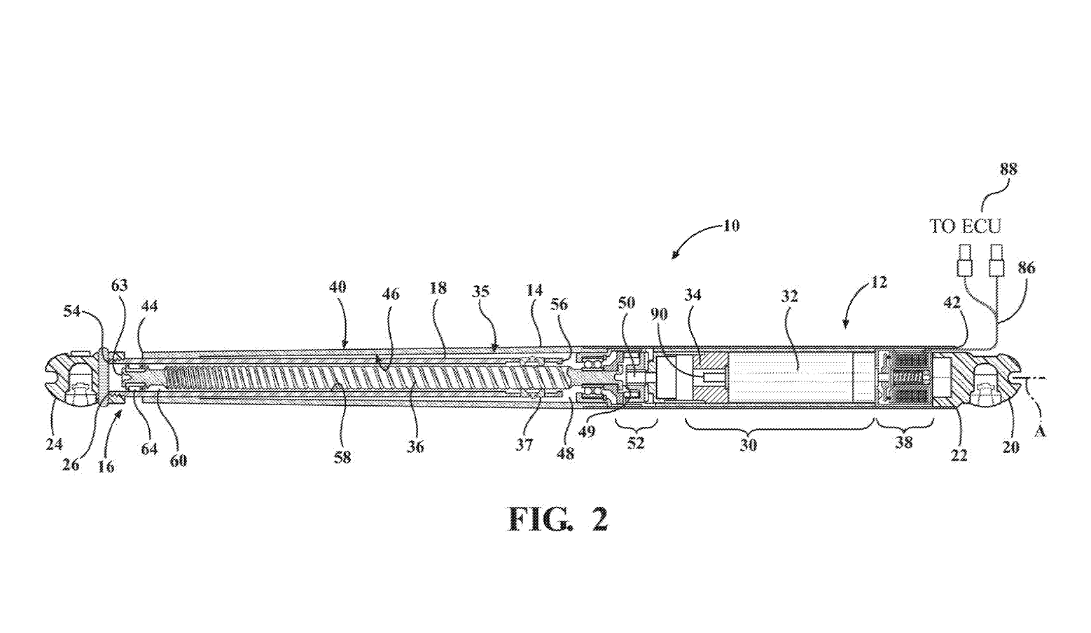

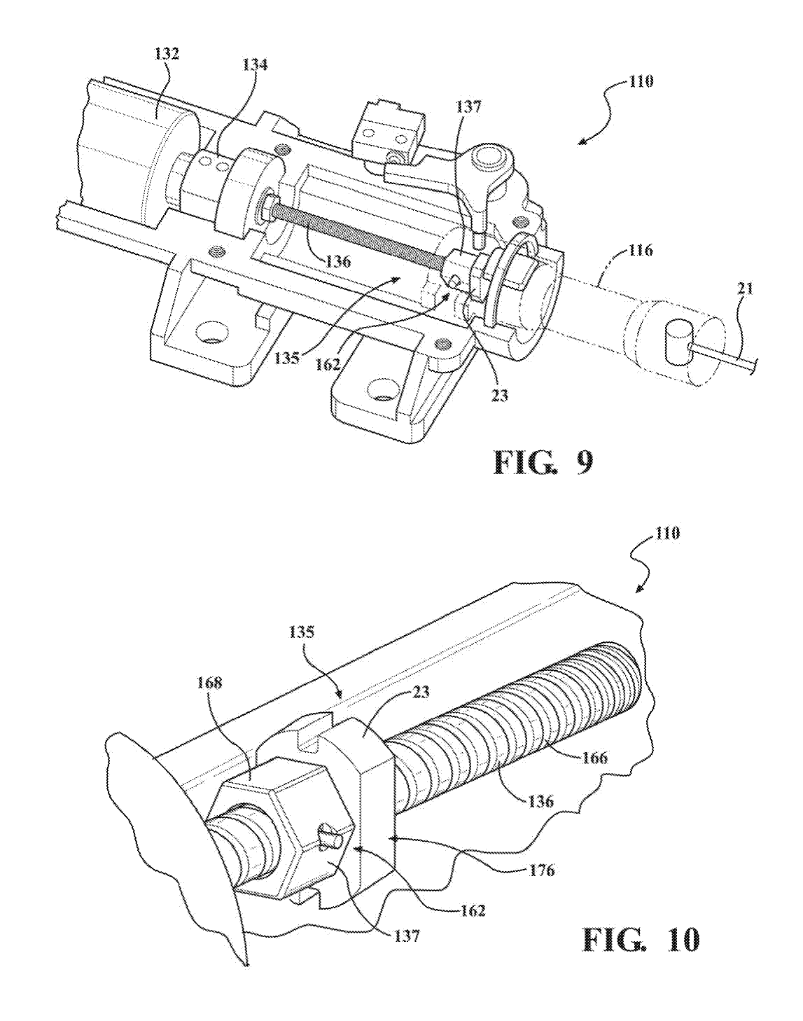

The strut 10, shown in FIG. 2, includes several features, and elimination thereof, which contribute to the improved operation, reduced weight and compact design of the strut 10. In addition to the inclusion of an electromechanical brake 38, which provides additional desired holding force to selectively prevent relative movement between the power drive unit 12 and the telescoping unit 16, the exemplary strut 10 does away with the need for a counterbalance spring member, such as a coil spring, or minimizes the size of the spring member, as is typically deployed within or about a telescoping unit of struts discussed in the background. The elimination of a counterbalance spring provides the ability to construct the electromechanical strut 10 with a reduced diameter and/or cross-sectional area, thereby allowing the weight of the strut 10 to be reduced, as a result of the minimized package size of the strut 10 and the omission of the material of the counterbalance spring, and the outer envelope to be reduced, thereby resulting in a compact design. It will be recognized and understood by one possessing ordinary skill in the art that the improved lead screw assembly 35, as discussed in more detail below, can be utilized in any electromechanical strut configuration to attain benefits therefrom, including struts having a counterbalance spring. While the illustrative embodiments herein refer to a lead screw assembly 35 for a closure panel, the lead screw assembly 35 can be employed for other powered applications requiring movement of objects where torque and speed control is desirable, such as part of a powered door check system, part of a powered window regulator system, and part of a cinch actuator assembly 110 (FIG. 9), as discussed further below. In accordance with another illustrative embodiment, it will be recognized and understood by one possessing ordinary skill in the art that the improved lead screw assembly 35, as discussed in more detail below, can be utilized in any non-powered counterbalance strut configuration, such as described herein above with reference to strut 10, however excluding a motor-gear assembly 30, which includes a motor 32, to attain benefits therefrom, including struts having a counterbalance spring. Such benefits may include a non-powered counterbalance for generating friction over predetermined ranges of movement of the closure panel 28, 29 (generating friction between the nut 37 and the lead screw 36 to slow the relative movement between the nut 37 and the lead screw 36 to thereby slow the movement of the closure panel 28, 29) or establishing locking (establishing a friction grip or locking action between the nut 37 and the lead screw 36) at a predetermined position of travel of the lift gate 28 e.g. locking set to be established, to hold the closure panel 28, 29 at a desired position, in a similar manner as described herein below, or over a predetermined range of travel of the closure panel 28, 29.

As shown in FIG. 2, the outer housing 14 has a tubular wall with an outer surface 40 that extends along a longitudinal central axis A between opposing first and second ends 42, 44 and an inner surface 46 bounding a cavity or chamber 48 sized for at least partial receipt of the motor-gear assembly 30 therein. The motor 32 and planetary gear set 34 are seated within the chamber 48. The variable pitch leadscrew 36 is disposed within the telescoping unit 16 to extend along the longitudinal central axis A and couples via an end 49 to an output shaft 50 of the power drive unit 12. In the illustrated embodiment, the planetary gear set 34, which is known in the art per se, and optional for use with power drive unit 12, provides about a 20:1 gear ratio reduction, by way of example and without limitation. The gear set 34, if included, can be provided having any desired gear ratio reduction. The power drive unit 12 features a coupling 52 that enables the power drive unit 12 to be quickly and easily attached with the telescoping unit 16. The motor 32 and the gear set 34 are located along the axis A between the lead screw 36 and the electromechanical brake assembly 38, such that the electromechanical brake assembly 38 is disposed between the motor 32 and the first end 42 of the housing 14, and the motor 32 is disposed between the gear set 34 and the electromechanical brake assembly 38. Alternatively, the electromechanical brake assembly 38 could be mounted on the opposite side of the motor 32 and gear set 34, if desired, as would be recognized by one skilled in the art upon viewing the disclosure herein.

The telescoping unit 16 includes the single-walled extensible tube 18 that extends along the longitudinal axis A between opposing first and second ends 54, 56 and has an inner surface 58 bounding a cavity or chamber 60 sized for clearance receipt of the leadscrew 36. One end 54 of extensible tube 18 is rigidly connected to the second pivot mount 24, such as via mating helical threads for interconnecting the parts, by way of example and without limitation.

The extensible tube 18 has the drive nut 37 of the lead screw assembly 35 fixedly mounted in its chamber 60 adjacent the second end 56 thereof, such as via press fit and/or bonded fixation therein or riveted connection, by way of example and without limitation. The drive nut 37 is threadedly coupled with the leadscrew 36 via one or more, and shown as a pair of diametrically opposed rotatable, also referred to as pivotal guide members 62, by way of example and without limitation, in order to convert rotational movement of the leadscrew 36 into linear motion of the telescoping unit 16 along the longitudinal central axis A of the strut 10. The terms rotatable and pivotal are intended to mean that the guide members 62 are free to move along an infinite number of axes, and that they are not confined to movement along a single axis. Accordingly, the term multi-directional or multi-axial It is to be recognized that a single pivotal guide member 62 could be used, a single pair of pivotal guide members 62, or an additional pair of pivotal guide members 62 could be incorporated, depending on the load requirements of the application, as discussed further below. To facilitate guiding the telescoping unit 16 in generally concentric relation with the housing 14 along the axis A, an annular, low friction wear sleeve 64 can be fixed adjacent an end 63 of the leadscrew 36 via any suitable fixation mechanism. The wear sleeve 64 remains axially fixed in relation to the lead screw 36 to facilitate smooth axial movement of the extensible tube 18 as it translates axially in response to axial movement of the drive nut 37 along at least one helical female thread groove, referred to hereafter simply as groove 66, of the leadscrew 36. If an additional pair of pivotal guide members 62 is incorporated, a plurality of grooves 66 could be provided, with one groove 66 receiving one pair of pivotal guide members 62 and another groove 66 receiving the other pair of pivotal guide members 62.

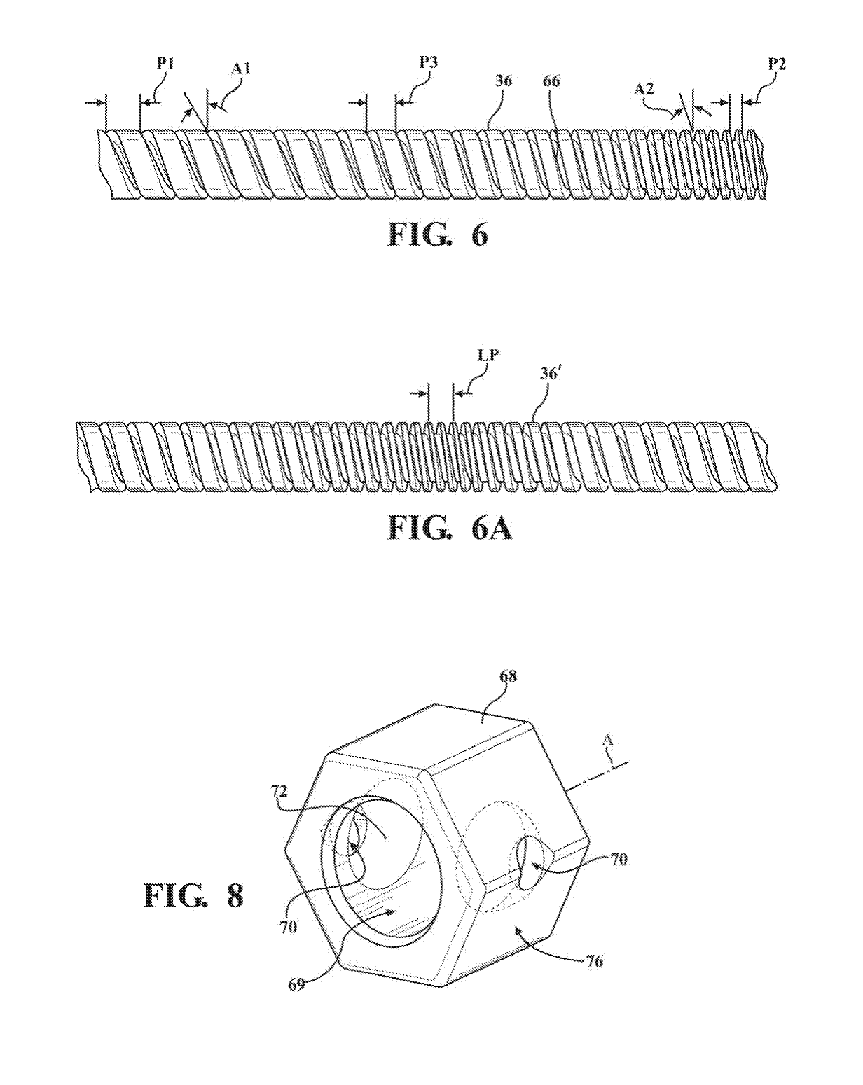

As best shown in FIG. 6, the lead screw 36 includes the helical groove 66 extending along its length between opposite ends 49, 63 (FIG. 2). The groove 66 is shown as having generally V-shaped sides 65, 67, which define a constant width of the groove 66, and having variable pitch, with the pitch shown, by way of example and without limitation, as varying continuously along its length. Accordingly, the groove 66 has a first pitch P1 adjacent the first end 49 that is coupled to the output shaft 50 and a second pitch P2 adjacent the second end 63 that is fixed to the wear sleeve 64, wherein first pitch P1 is greater than the second pitch P2, with the pitch continually varying therebetween from the smallest second pitch P2 gradually increasing in constant fashion to the greatest first pitch P1. Accordingly, with the pitch being continuously variable, the pitch constantly decreases from first pitch P1 toward second P2. As such, a central region of the groove 66 generally midway between the opposite ends 49, 63 has a pitch P3, wherein P1 is greater than P3, and P3 is greater than P2 (P1>P3>P2). Accordingly, as one skilled in the art will understand in view of the disclosure herein, the helix angle of the groove 66 also continuously decreases from end 49 toward end 63, as shown with helix angle A1 being greater than helix angle A2. While reference is made herein to the pitch of the lead screw 36 being continuously variable, other configurations are possible. For example, the pitch of the lead screw 36 can be varied in accordance with any design requirements such as for establishing locking (establishing a friction grip or locking action between the nut 37 and the lead screw 36) at a predetermined position of travel of the lift gate 28 e.g. locking set to be established, to hold the closure panel 28, 29 at a desired position, at either or both of the ends opposite ends 49, 63 (with decreased pitch) while establishing efficient travel in the middle portion between the opposite ends 49, 63 (with increased pitched). Additionally, as shown in FIG. 6A, the pitch of a lead screw 36′ in accordance with another aspect of the disclosure can be varied for establishing a locking point in a mid-position of travel of the lift gate 28, and thus, a suitable locking pitch region LP (decreased pitch region) can be established within the middle portion of the lead screw 36′ between the opposite ends, and thus, rather than the pitch constantly increasing from one end to the opposite end, the pitch can constantly increase from one end to the locking pitch region LP, wherein the pitch suddenly decreases, and then the pitch can continue to constantly increase from the locking pitch region LP to the opposite end. Another advantage of the variable pitch lead screw 36 allows for the pitch to be correlated to the motor torque curve of the motor 32. The pitch along the length of the lead screw 36 can be set so as to keep the torque output of the motor 32 within the motor's efficient range of operation by increasing or decreasing the pitch with a given load profile. For example, where the load on the motor 32 is lighter (e.g. due to a lighter lift gate 28, or an angle of the lift gate 28 resulting in less loading on the strut 10), normally the speed of the motor 32 will tend to increase, so by correlating an increase in the pitch corresponding to a point during the travel of the lift gate 28 and reducing the motor speed, the efficiency of the motor operation 32 can be improved, which in turn contributes to the ability to do away with a gear-reduction planetary gear set 34, depending on the application. With reference now to FIG. 11, reducing the speed of the motor 32 from 45 rpm to 40 rpm would increase the torque output from approximately 2 in-lbs to 3 in-lbs torque while operating the motor 32 in its more efficient range as shown with reference to the efficiency curve in FIG. 11. Alternatively, if the torque output was approximately 6 in-lbs, the pitch can be set to increase at this point to increase mechanical advantage. As a result, the RPM of the motor 32 would correspondingly increase and torque decrease, to thereby shift the motor 32 into a more efficient operating range.

The drive nut 37 includes the pivotal guide members 62 and a drive nut body 68 formed as a separate piece of material from the guide members 62. The drive nut body 68 has a through bore 69 configured for close, clearance receipt of the lead screw 36 therethrough. The drive nut body 68 further includes receptacles 70 on diametrically opposite sides of the through bore 69, with the receptacles 70 being configured facing into the through bore 69 and facing the longitudinal central axis A for captured receipt of the pivotal guide members 62 therein. The receptacles 70 are further configured to facilitate pivotal movement of the pivotal guide members 62 along an infinite number of axes therein, thereby allowing the pivotal guide members 62 to freely move and follow the varying pitch and varying helix angle groove 66 of the lead screw 36. In the non-limiting exemplary embodiment, the receptacles 70 are shown has having semi-spherically shaped, concave inner walls 72 configured for smooth, sliding engagement with a generally bulbous guide member body 74 of the pivotal guide members 62, wherein the guide member body 74 is shown as having a semi-spherically shaped, convex outer surface 75 for closely mating engagement with the inner walls 72 to promote free multi-directional movement along an infinite number of axes therebetween. Accordingly, the radii of the semi-spherical surfaces of the inner walls 72 and the outer surfaces 75 can be the same or substantially the same (substantially is intended to mean the radii could vary slightly relative to one another, with it being contemplated that the radii of the outer surfaces 75 being slightly less than the radii of the inner walls 72). The drive nut body 68 has an outer surface 76 that can be shaped as desired for fixation to the extensible tube 18, such that the extensible tube 18 moves conjointly with the drive nut 37 as the drive nut 37 translates along the length of the rotating lead screw 36.

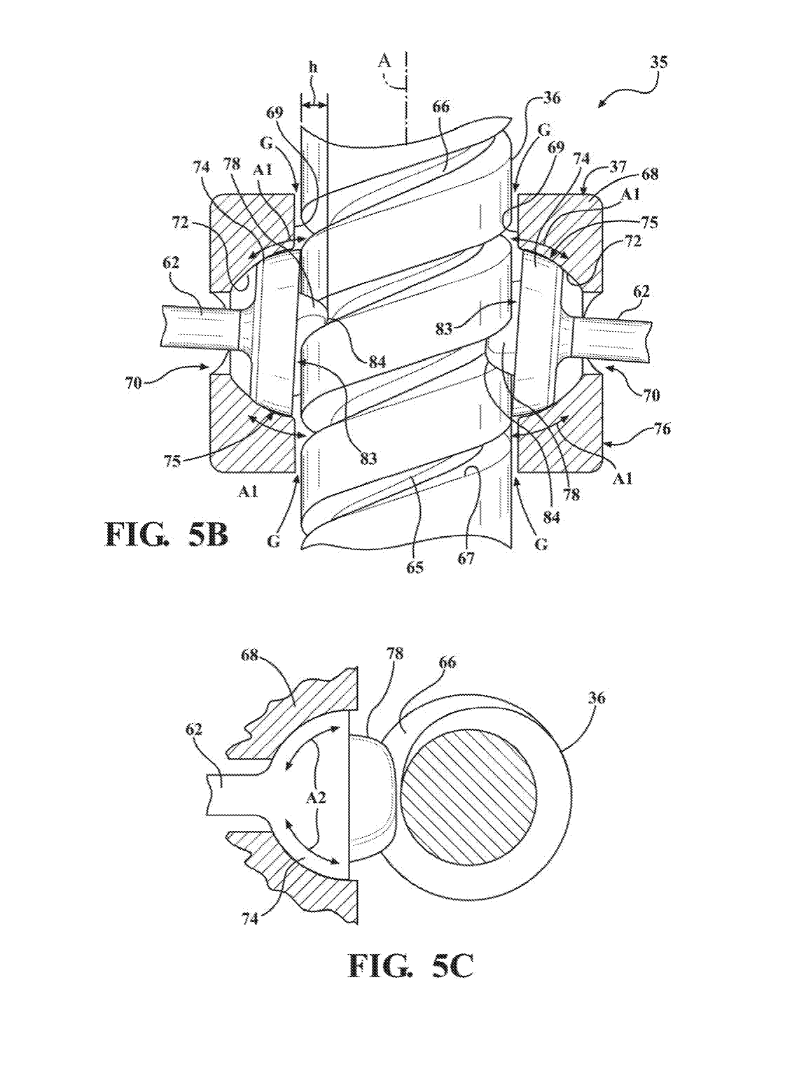

Each of the separate pivotal guide members 62 have an elongate guide protrusion or tooth 78 configured for sliding receipt within the groove 66. The elongate dimension of the tooth 78 allows for high loads to be distributed between the pivotal guide members 62 and the tooth 78 to prevent/reduce breakage or shearing between the tooth 78 and the pivotal guide members 62. Such a force distribution between the tooth 78 and the pivotal guide member 62 can allow for the pivotal guide members 62 and the tooth 78 to be integrally formed from a plastic material through injection molding for example, as compared to a metal material. Optionally, the pivotal guide members 62 and the tooth 78 can be integrally formed from metal. The teeth 78 are shown having opposite sides 80, 82 extending outwardly from a radially inwardly facing face 83 of the guide member body 74 to define a height (h) of the teeth 78, wherein the opposite sides 80, 82 also extend along the face 83 in elongate fashion to define a length (L) of the teeth 78. The length L of the teeth 78 is greater than the height h, and in an exemplary embodiment, is between about 3-10 times greater, by way of example and without limitation, thereby providing greatly increased guidance and strength relative to a cylindrically shaped pin or dowel configuration. The opposite sides 80, 82 are shown as being slightly inclined to converge toward one another from the face 83 toward an elongate terminal free edge 84. Accordingly, the teeth 78 are tapered to converge into the through bore 69 of the drive nut body 68 and to mate or closely match with a corresponding, generally V-shaped, taper of the groove 66. The face 83 can be contoured to facilitate pivoting movement of the pivotal guide members 62 relative to the drive nut body 68 and to change pitch angle as the pitch angle of the groove 66 changes during use, and/or the face 83 may be maintained in spaced relation from the lead screw 36 providing a gap G between the drive nut body 68 and lead screw 36 via interaction of the teeth 78 with the groove 66, thereby facilitating multi-directional pivotal movement of the pivotal guide members 62 relative to the drive nut body 68, and further, to facilitate pivotal, swiveling movement of the drive nut body 68 relative to the lead screw 36 along the direction of the longitudinal central axis A (FIGS. 5A and 5B illustrate arrows A1 of directional movement of guide members 62) as well as circumferentially about the longitudinal central axis A (FIG. 5C illustrate arrows A2 of directional movement of guide members 62).

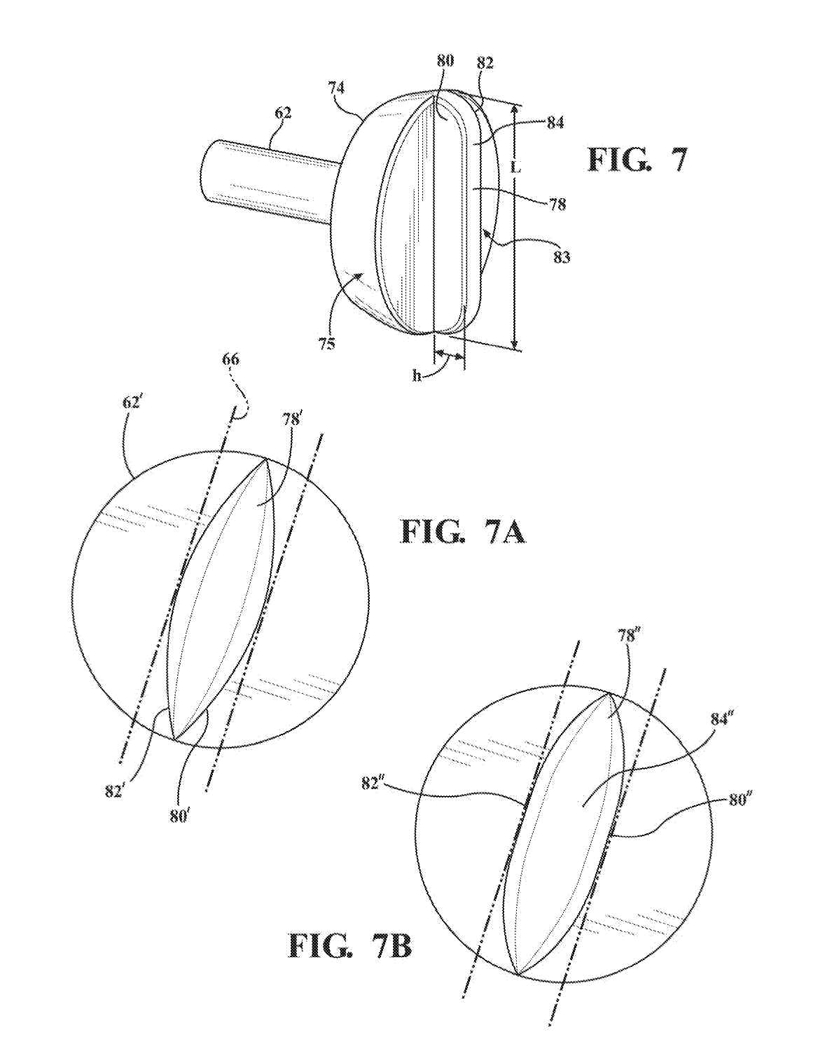

In accordance with a further aspect of the disclosure, as shown in FIG. 7A, teeth 78′ may be formed having convex contoured sides 80′, 82′, with the contour of the sides 80′, 82′ having a half-football shape or oval shape. The contour of the sides 80′, 82′ enhances the ability of the teeth 78′ and pivotal guide members 62′ to move freely along an infinite number of axes relative to the drive nut body 68 and relative to the lead screw 36. The half-football contour or oval contour, as shown in FIG. 7A, provides point contact between the teeth 78′ and the sides 65, 67 of groove 66. The point contact not only enhances multi-directional, free pivotal movement of pivotal guide members 62′, but further facilitates maintaining the teeth 78′ in centered relation within the groove 66, similar in theory to a prow of a ship, while also minimizes the risk of binding (also referred to as sticking or locking) between the pivotal guide members 62′ and the lead screw 36, thus, resulting in minimal static and sliding friction.

In accordance with yet a further aspect of the disclosure, as shown in FIG. 7B, teeth 78″ may be formed having a convex, half-football shape or oval shape as discussed above; however, in addition, the sides can be provided having flattened side portions 80″, 82″ located midway or centrally along the opposite sides of teeth 78″. The length and radial depth (location between a terminal free edge 84″ and root of the teeth 78″) and/or radial extent (how far along the teeth 78″ the flattened side portions 80″, 82″ extend from the terminal free edge 84″ radially inwardly) of the flattened side portions 80″, 82″ can be provided as desired, thereby determining the precise location, width, and area of the line or patch contact between the teeth 78″ and the sides 65, 67 of the groove 66. Accordingly, precise control over the size and shape of the line or patch contact between the teeth 78″ and the sides 65, 67 of the groove 66 can be attained, thereby enhancing the ability to provide the loading and stability desired therebetween.

As shown in FIG. 2, an electrical lead 86 extends from an electronic control unit (ECU) 88 into electrical communication with the electromechanical strut 10, and in particular, with an electronic board of the motor 32 which can include power leads and hall sensor leads and the electromechanical brake assembly 38, also referred to as brake 38, as will be understood by one skilled in the art. When the motor 32 and brake 38 are energized via electrical current from the lead 86, the brake 38 is moved to a “disengaged state,” and a motor shaft 90 rotates about the longitudinal central axis A to drive the planetary gear set 34, and thus the leadscrew 36, thereby driving the drive nut 37 and extensible tube 18 axially along axis A to various positions. For example, the motor shaft 90 can drive the extensible member 16 to an extended position to open the lift gate 28 or side door 29. The motor shaft 90 can also drive the extensible member 16 to a retracted positon to close the lift gate or door. However, the brake 38 is normally in the “engaged state” to prevent movement of the motor shaft 90, the leadscrew 36, and thus the telescoping unit 16.

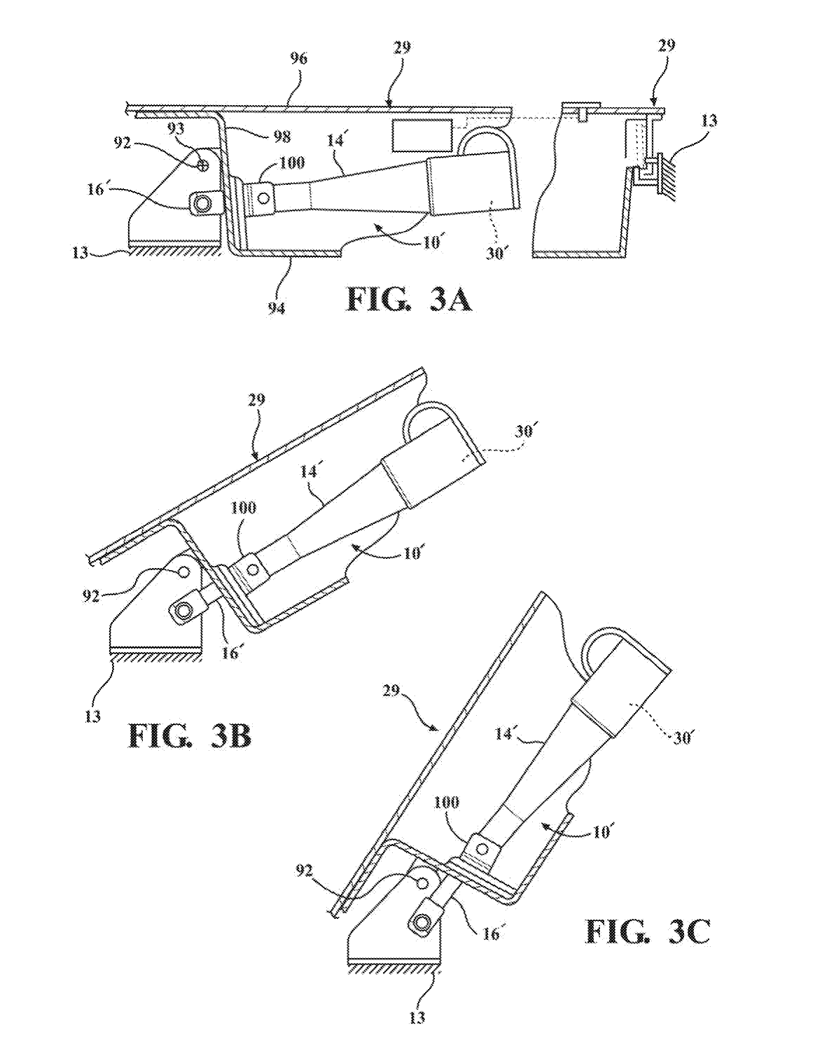

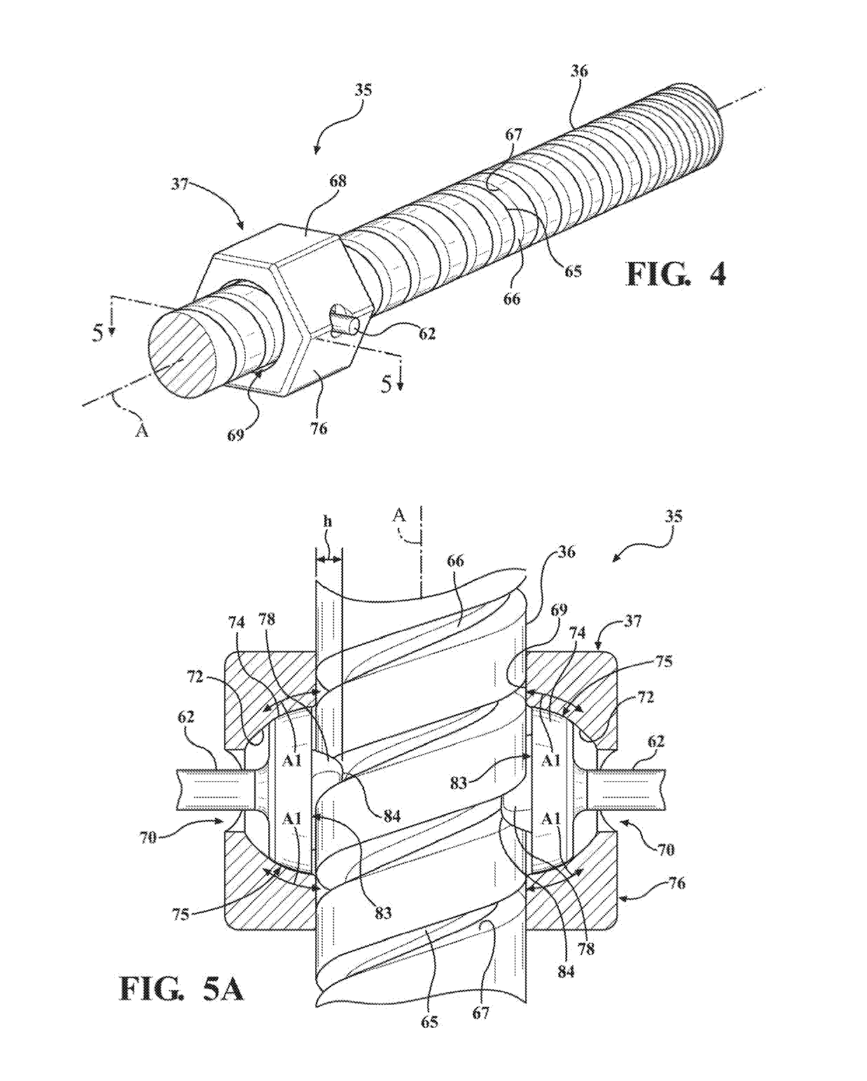

As noted above, the side swing doors 29 can also be equipped with a non-limiting embodiment of an electromechanical strut 10′ constructed in accordance with the teachings, as shown in FIGS. 3A-3C, wherein the same reference numerals as used above, offset with a prime symbol (′) are used to identify like features. The strut 10′ is operational to move the vehicular swing door 29 between a closed position, intermediate open position, and a fully-open position, respectively. The swing door 29 is pivotally mounted on at least one hinge 92 connected to the vehicle body 13 (not shown in its entirety) for rotation about a vertical axis 93. For greater clarity, the vehicle body 13 is intended to include the ‘non-moving’ structural elements of the vehicle such as the vehicle frame (not shown) and body panels (not shown).

The swing door 29 includes inner and outer sheet metal panels 94, 96 with a connecting portion 98 between the inner and outer sheet metal panels 94, 96. The strut 10′ has a support structure, such as a housing 14′, a power-operated motor gear assembly 30′ mounted within housing 14′, and an extensible actuation member 16′ drivingly coupled to power-operated drive mechanism 30′. The extensible actuation member 16′ is moveable relative to housing 14′ between retracted and extended positions to effectuate swinging movement of swing door 29. The strut 10′ may be mounted within an internal door cavity formed between the inner and outer sheet metal panels 94, 96. Specifically, the actuator housing 14′ is fixed to the swing door 29 via a mounting bracket 100 mounted to the connecting door portion 98 within the internal door cavity. The terminal end of the extensible actuation member 16′ is mounted to the vehicle body 13.

The housing 14′ defines a cylindrical chamber in which the extensible actuation member 16′ translates. The extensible actuation member 16′ includes a lead screw assembly as discussed above for lead screw assembly 35, including a lead screw and drive nut, as discussed above for lead screw 36 and drive nut 37. Accordingly, further discussion is believed unnecessary.

As mentioned above, a lead screw assembly 135 constructed in accordance with the disclosure can be incorporated into cinch actuator assembly 110 to effect cinching (locking) a closure panel latch 17 of vehicle 11. The reference numerals used to identify features of cinch actuator assembly 110 and lead screw assembly 135 are the same as used above for strut 10 and lead screw assembly 35, offset by a factor of 100. Cinch actuator assembly 110, with the incorporation of lead screw assembly 135, can be provided as discussed in U.S. Publication 2016/0060922 (the '922 publication), filed on Sep. 1, 2015, which is commonly owned by applicant herein, wherein the entirety of the disclosure of the '922 publication is incorporated herein by way of reference.

Cinch actuator assembly 110 is shown in FIG. 9 with a top housing and cable cover removed to show internal components thereof, including the lead screw assembly 135. The cinch actuator assembly 110 is typically used in a vehicle application, for example to cinch the closure panel latch, shown as a door latch 17 of a vehicle door 29, by way of example and without limitation, via translating movement of a cable 21 via translation of a drive nut 137 along a lead screw 136 of the lead screw assembly 135. When the cinch actuator assembly 110 is deployed in a fully open position, the door latch 17 is not cinched (un-cinched), and thus the door 29 can be opened or closed upon actuation of a door handle 19. When the cinch actuator assembly 110 is in a cinched position, the door latch 17 is cinched, and thus the door 29 cannot be opened or closed upon actuation of a door handle 29.

Cinch actuator assembly 110 includes a motor 132 operably coupled to lead screw assembly 135 by an adaptor 134, wherein lead screw assembly 135 is operably coupled to an extensible member 116. The motor 132 rotates in both clockwise (first direction) and counterclockwise (second direction) directions, and in turn rotates the lead screw 136 in the same first and second directions. The motor 132 rotates the lead screw 136 in the first direction to move the extensible member 116 and a cable 21 fixed thereto in a first axial direction from the fully opened position (un-cinched) to the fully cinched position. The motor 132 also rotates the lead screw 136 in a second opposite direction to move the extensible member 116 and cable 21 from the fully closed, cinched position to the fully opened, un-cinched position.

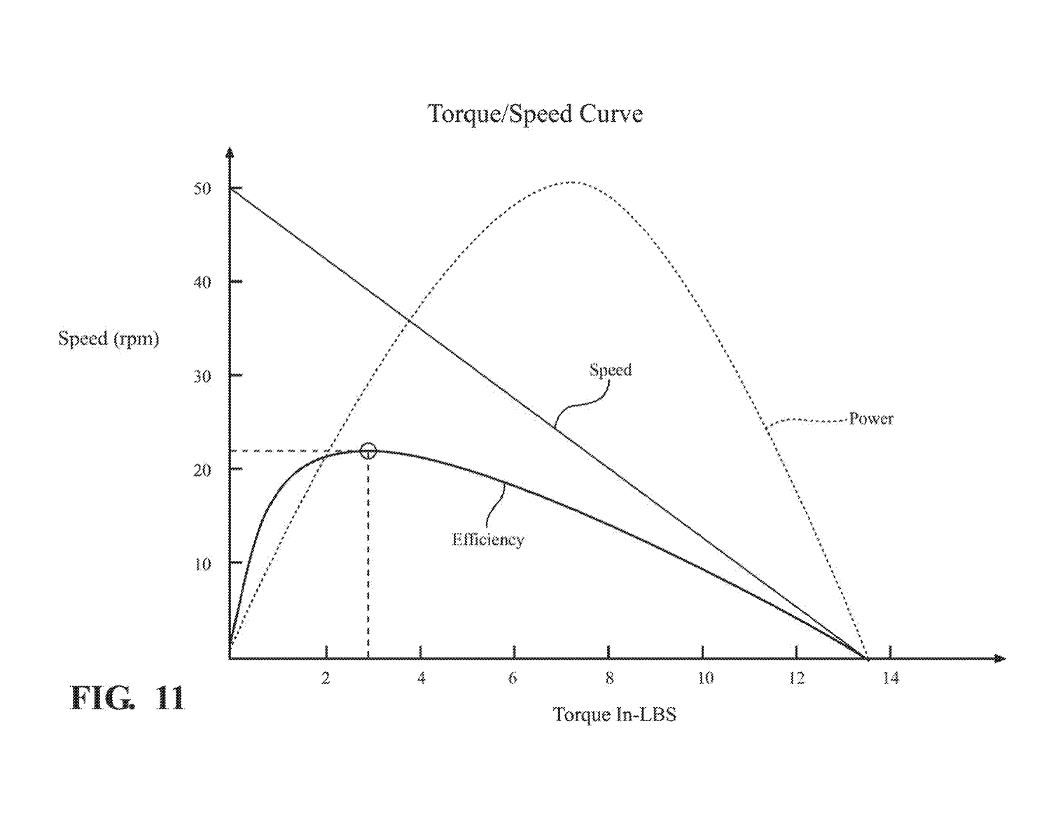

As best shown in FIG. 10, the lead screw assembly 135 is the same, or substantially the same as described above for lead screw assembly 35. Accordingly, lead screw 136 includes the groove 166 extending along its length, with groove 166 having variable pitch, with the pitch shown, by way of example and without limitation, as varying continuously along its length. It is to be recognized that groove 166 can be formed otherwise, as discussed above for groove 66.

Likewise, lead screw assembly 135 includes drive nut 137 with pivotal guide members 162 and a drive nut body 168. The pivotal guide members 162 and drive nut body 168 are generally constructed as discussed above with regard to pivotal guide members 62 and drive nut body 68, and thus, further discussion is believed unnecessary, as one skilled in the art will ready understand the similarities in view of the disclosure herein. The drive nut body 168 has an outer surface 176 that can be shaped as desired for fixation to, or integration with (e.g. integrally formed), the extensible member 116, shown as having a flange 23 configured for fixation to extensible member 116 such that the extensible member 116 moves conjointly with the drive nut 137 as the drive nut 137 translates along the length of the rotating lead screw 136. Otherwise, lead screw assembly 135 is generally constructed as discussed above with regard to lead screw assembly 35, and thus, further discussion is believed unnecessary, as one skilled in the art will ready understand the similarities in view of the disclosure herein.

For the sake of simplicity, the reference numerals referenced hereafter are directed to the strut 10 and to the application of the lift gate 28, though it is to be recognized that the discussion applies equally to the strut 10′ and the swing doors 29 and to the cinch actuator assembly 110. In use, when the lift gate 28 is closed, the extensible member 16 is retracted, and thus, the drive nut 37 is registered in radial alignment and in threaded engagement with the portion of the lead screw 36 adjacent end 49. Accordingly, the drive nut 37 is positioned along the relatively high pitch, high helix angle region P1, A1 of the lead screw 36. With the lift gate 28, it is to be recognized that the entirety or substantial (meaning it could be slight less than, but the vast majority) entirety of the weight of the lift gate 28 is supported via hinges from which the lift gate 28 hangs and pivots. As such, during initial actuation and opening of the lift gate 28, the amount of force/torque required to initiate the opening is relative low, as compared to the force/torque required as the lift gate 28 continues to be swung outwardly and upwardly, as will be recognized by one possessing ordinary skill in the art. Accordingly, during the actuation of the strut 10, the drive nut 37 is able to be driven by the motor 32 along the more aggressive, increased pitch P1 region under relatively low torque, thereby not placing the motor under high load/torque demand. As the lift gate 28 continues to move toward its fully open position, and the force/torque requirements continue to increase, due to having to move an ever increasing load imparted by the lift gate 28 swinging outwardly, the drive nut 37 translates along the length of the lead screw 36 toward end 63 with the pitch and helix angle of the lead screw groove 66 continuously varying, shown as continuously decreasing. Accordingly, as the lead screw pitch decreases, the torque required to turn the lead screw 36 also decreases and the ability to open the ever increasing load of the lift gate 28 is made easier, thereby allowing the motor 32 to increase in rotational speed, if desired, without causing an increase in load on the motor. Accordingly, it is to be recognized that as the pitch of the lead screw groove 66 decreases, so too do the translational linear speed of the drive nut 37 if the rotational speed of the output shaft 50 remains constant. As such, it may be desired to constantly increase the rotational speed of the output shaft 50 if a constant swing rate of the lift gate 28 is desired, and with the decrease in torque required to turn the lead screw 36, the motor 32 is able to increase the rotation speed of the motor shaft 90 without difficulty.

Of significant importance, while the drive nut 37 is translating along the length of the lead screw 36, is the ability of the teeth 78 to slide along the groove 66 with minimal friction, and thus with minimal wear, as the pitch and helix angle of the groove 66 changes. The ability of the teeth 78 to traverse the changing pitch of the groove 66 without binding is made possible by the pivotal freedom of the body 74 of the guide members 62 within the receptacles 70 of the drive nut body 68. The pivotal freedom of the guide members 62 allows the sides 80, 82 of the teeth 78 to constantly change their helix angle orientation to remain in alignment along the same helix angle orientation with sides 65, 67 of the groove 66 such that the relative friction between the teeth 78 and the sides 65, 67 of the groove 66 remains low and constant. Accordingly, the teeth 78 of the guide members are self-adjusting to attain the same orientation and helix angle as the portion of the groove 66 in which they reside. As the helix angle of the groove 66 changes, so too does the orientation and associated helix angle of the teeth 78. Of course, it is to be recognized that the guide members 62 can be configured other than as shown, as will become apparent to one possessing ordinary skill in the art upon viewing the disclosure herein, with the embodiment discussed and illustrated being a non-limiting, exemplary embodiment.

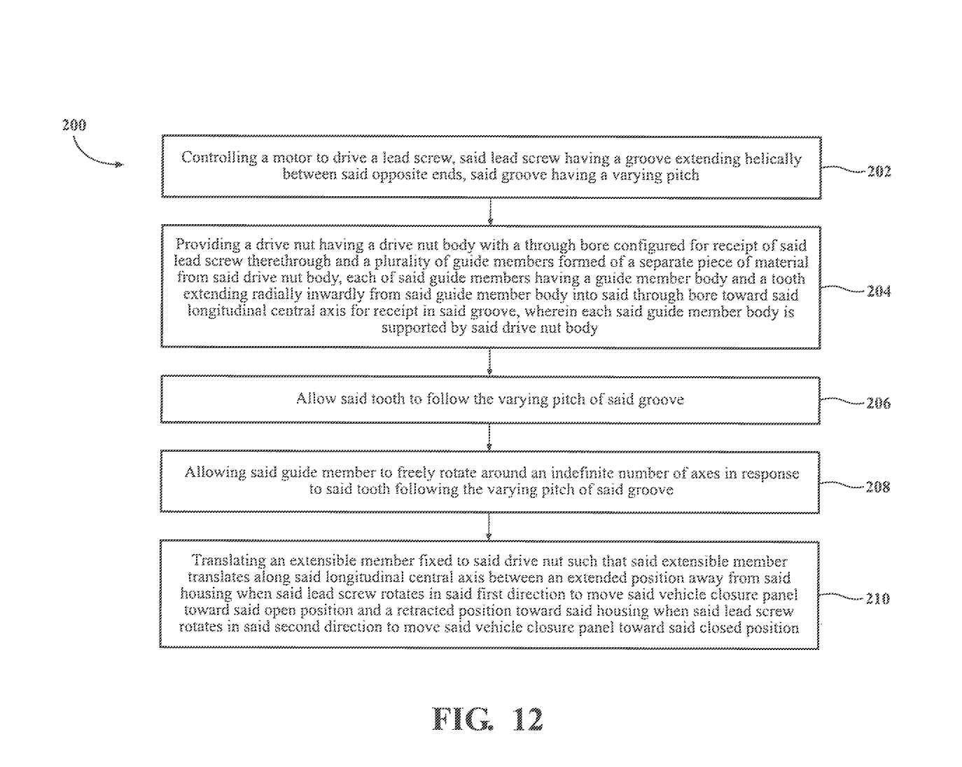

Now referring to FIG. 12, there is provided a method at 200 for moving a vehicle closure panel relative to a vehicle body between a closed position and an open position. The method 200 includes, at 202, the step of controlling a motor to drive a lead screw, with the lead screw having a groove extending helically between said opposite ends, with the groove having a varying pitch extending lengthwise along a longitudinal central axis. The method further includes, at 204, the step of providing a drive nut having a drive nut body with a through bore configured for receipt of the lead screw therethrough and a plurality of guide members formed of a separate piece of material from the drive nut body, with each of the guide members having a guide member body and a tooth extending radially inwardly from the guide member body into the through bore toward the longitudinal central axis for receipt in the groove, wherein each guide member body is supported by the drive nut body. The method further includes, at 206, the step of allowing the tooth to follow the varying pitch of the groove, and further, at 208, allowing the guide member to freely rotate around an indefinite number of axes in response to the tooth following the varying pitch of the groove. The method further includes, at 210, the step of translating an extensible member fixed to the drive nut such that the extensible member translates along the longitudinal central axis between an extended position away from the housing when the lead screw rotates in the first direction to move the vehicle closure panel toward the open position and a retracted position toward the housing when the lead screw rotates in the second direction to move the vehicle closure panel toward the closed position. In accordance with a further aspect, the method 200 further includes the step of controlling the motor at a constant output speed, providing the lead screw with a varied pitch such that the constant output speed of the motor drives the translation of the extension member at a constant rate to move the vehicle closure panel toward the open position and a retracted position toward the housing at a constant rate.

The foregoing description of the embodiments has been provided for purposes of illustration and description. It is not intended to be exhaustive or to limit the disclosure. Individual elements, assemblies/subassemblies, or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

What is claimed is:

1. An actuator assembly, comprising:
a lead screw extending lengthwise along a longitudinal central axis between opposite ends, said lead screw having a groove extending helically along the length between said opposite ends, said groove having a varying pitch along at least a portion of the length of said lead screw; and
a drive nut having a body with a through bore configured for receipt of said lead screw therethrough, said drive nut having teeth extending radially inwardly into said through bore toward said longitudinal central axis for receipt in said groove, wherein said teeth are formed of a separate piece of material from said body and are free to move relative to said body to allow said teeth to follow the varying pitch of said groove.

2. The actuator assembly of claim 1, wherein said body of said drive nut has diametrically opposed receptacles facing radially inwardly toward said longitudinal central axis, each of said teeth being formed as an integral piece of material with a separate guide member body, each said guide member body being configured for pivotal movement along an infinite number of axes in a separate one of said diametrically opposed receptacles.

3. The actuator assembly of claim 2, wherein said diametrically opposed receptacles have concave, semi-spherical inner walls and said guide member bodies having convex, semi-spherical outer surfaces, said concave semi-spherical inner walls mating with said convex semi-spherical outer surfaces for relative pivotal movement along an infinite number of axes therebetween.

4. The actuator assembly of claim 2, wherein each of said teeth have opposite elongate sides converging from said guide member body toward said longitudinal central axis to a free edge received in said groove.

5. The actuator assembly of claim 4, wherein each of said teeth have a height extending from said guide member body to said free edge and a length extending along said guide member body, wherein said length is greater than said height.

6. The actuator assembly of claim 1, wherein said varying pitch varies along the entire length of said groove.

7. The actuator assembly of claim 6, wherein said varying pitch continually varies from a first pitch in constant decreasing fashion to a second pitch.

8. The actuator assembly of claim 1, further comprising:
a housing bounding an inner chamber;
a motor;
said lead screw supported in said inner chamber and being operably coupled to said motor for rotation in opposite first and second directions in response to selective actuation of said motor; and
an extensible member;
wherein said drive nut is fixed to said extensible member such that said extensible member translates along said longitudinal central axis between an extended position away from said housing when said lead screw rotates in said first direction and a retracted position toward said housing when said lead screw rotates in said second direction.

9. The actuator assembly of claim 8, wherein said extensible member is a tubular member disposed within said housing and about said lead screw, said extensible member being configured for attachment to a closure panel of a motor vehicle for moving the closure panel between an open position and a closed position.

10. The actuator assembly of claim 8, wherein said extensible member is configured for operable attachment to a latch of a motor vehicle closure panel to move the latch between a cinched position and an un-cinched position.

11. An actuator assembly for moving a vehicle closure panel relative to a vehicle body between a closed position and an open position, comprising:
a housing bounding an inner chamber;
a motor;
a lead screw extending lengthwise along a longitudinal central axis within said inner chamber between opposite ends, one of said ends being operably coupled to said motor for rotation of said lead screw in opposite first and second directions in response to actuation of said motor, said lead screw having a groove extending helically between said opposite ends, said groove having a varying pitch;
a drive nut having a drive nut body with a through bore configured for receipt of said lead screw therethrough and a plurality of guide members formed of a separate piece of material from said drive nut body, each of said guide members having a guide member body and a tooth extending radially inwardly from said guide member body into said through bore toward said longitudinal central axis for receipt in said groove, wherein each said guide member body is supported by said drive nut body for free movement relative thereto to allow said tooth to follow the varying pitch of said groove; and
an extensible member fixed to said drive nut such that said extensible member translates along said longitudinal central axis between an extended position away from said housing when said lead screw rotates in said first direction to move said vehicle closure panel toward said open position and a retracted position toward said housing when said lead screw rotates in said second direction to move said vehicle closure panel toward said closed position.

12. The actuator assembly of claim 11, wherein said drive nut body has diametrically opposed receptacles facing radially inwardly toward said longitudinal central axis, each said guide member body being configured for multi-directional pivotal movement in a separate one of said diametrically opposed receptacles.

13. The actuator assembly of claim 12, wherein said diametrically opposed receptacles have a concave, semi-spherical contour and said guide member bodies having a convex, semi-spherical contour, said concave semi-spherical contour mating with said convex semi-spherical contour for relative multi-directional pivotal movement therebetween.

14. The actuator assembly of claim 11, wherein each of said teeth have opposite elongate sides converging from said guide member body toward said longitudinal central axis to a free edge received in said groove.

15. The actuator assembly of claim 14, wherein each of said teeth have a height extending from said guide member body to said free edge and a length extending along said guide member body, wherein said length is greater than said height.

16. The actuator assembly of claim 15, wherein said length is between about 3-10 times greater than said height.

17. The actuator assembly of claim 11, wherein said varying pitch varies along the entire length of said groove.

18. A cinch actuator assembly for moving a latch of a vehicle closure panel between cinched and un-cinched positions, comprising:
a motor;
a lead screw extending lengthwise along a longitudinal central axis between opposite ends, said lead screw operably coupled to said motor for rotation of said lead screw in opposite first and second directions in response to actuation of said motor, said lead screw having a groove extending helically between opposite ends of said lead screw, said groove having a varying pitch;
a drive nut having a drive nut body with a through bore configured for receipt of said lead screw therethrough and a plurality of guide members formed of a separate piece of material from said drive nut body, each of said guide members having a guide member body and a tooth extending radially inwardly from said guide member body into said through bore toward said longitudinal central axis for receipt in said groove, wherein each said guide member body is supported by said drive nut body for multi-directional pivotal movement relative thereto to allow said teeth to follow the varying pitch of said groove; and
an extensible member fixed to said drive nut such that said extensible member translates along said longitudinal central axis between an extended position when said lead screw rotates in said first direction and a retracted position when said lead screw rotates in said second direction to move the latch from one of the cinched and un-cinched positions to the other of the cinched and un-cinched positions.

19. The cinch actuator assembly of claim 18, wherein said drive nut body has diametrically opposed receptacles facing radially inwardly toward said longitudinal central axis, each said guide member body being configured for multi-directional pivotal movement in a separate one of said diametrically opposed receptacles.

20. A method for moving a vehicle closure panel relative to a vehicle body between a closed position and an open position, comprising:
providing a lead screw having a helical groove extending about a longitudinal central axis between opposite ends, with the helical groove having a varying pitch extending along the longitudinal central axis;
providing a motor;
controlling the motor to drive the lead screw;
providing a drive nut having a drive nut body with a through bore configured for receipt of the lead screw therethrough and a plurality of guide members formed of a separate piece of material from the drive nut body, with each of the guide members having a guide member body and a tooth extending radially inwardly from the guide member body into the through bore toward the longitudinal central axis for receipt in the helical groove, wherein each guide member body is supported by the drive nut body;
allowing the tooth to follow the varying pitch of the helical groove;
allowing the guide member to freely rotate around an indefinite number of axes in response to the tooth following the varying pitch of the helical groove; and
translating an extensible member fixed to the drive nut such that the extensible member translates along the longitudinal central axis between an extended position away from the housing when the lead screw rotates in the first direction to move the vehicle closure panel toward the open position and a retracted position toward the housing when the lead screw rotates in the second direction to move the vehicle closure panel toward the closed position.
